(19) United States
(12) Patent Application Publication
(10) Pub. No.: US 2009/0100456 A1
(43) Pub. Date: Apr. 16, 2009

(54) METHOD AND APPARATUS FOR MONITORING ONLINE VIDEO

(76) Inventor: John HUGHES, Berkeley, CA (US)

Correspondence Address: GLENN PATENT GROUP, 3475 EDISON WAY, SUITE L, MENLO PARK, CA, 94025, US

(21) Appl. No.: 11/871,880

(22) Filed: Oct. 12, 2007

(51) Int. Cl. H04N 7/16

(52) U.S. Cl. 725/14

(57) ABSTRACT

A method and apparatus for online video analytics provides a cross-platform, online video analytics solution that enables advertisers and content publishers to assess the effectiveness of their video clips better, gain more insights into viewership demographics and behavior, and track and compare online video viewership across multiple video sharing websites.

### BACKGROUND OF THE INVENTION

1. Technical Field

The invention relates to the monitoring of a website. More particularly, the invention relates to a method and apparatus for monitoring online video.

2. Description of the Prior Art

The number and popularity of Web 2.0 websites have rapidly increased. Generally, a Web 2.0 website is a site where a user is able to create an account, upload, share, contribute, comment, vote, or read personal opinions of other users, all on the same site. Many of the Web 2.0 websites, such as YouTube™, MetaCafe™, Google® video, Yahoo!® video, myspace.com®, users' blogs, and others, provide video sharing services.

A video sharing (or online video) service allows individuals or content publishers to upload video clips to an Internet website. The host website stores the video clip on its server, and provides different types of functions to allow others to view the video clip. For example, the host may allow commenting and rating of a video clip. Many services have options for private sharing and other publication options. Video sharing services can be classified into several categories including user generated video sharing websites, video sharing platforms, white label providers, and web based video editing websites.

As video hosting websites become increasingly popular, such websites provide a platform for traditional publishers, such as TV broadcasters, to use such video hosting websites as another medium to display media content. For example, CBS and CNN networks often publish video clips on YouTube. For such publishers it is highly desirable to know the ratings of their published video clips. In television the ratings, e.g. Nielsen Ratings, determine the audience size and composition of television programming. This method is not applicable for the Internet.

In the related art there are different techniques to determine the popularity of a website. One technique known in the art refers to a page-hit or page views). The page-hit refers to an event in which a server receives a request for a page and then serves up the page. A common measure of traffic at a website is the number of page-hits, especially in an advertising context for particular pages or sets of pages. Page-hit counts are a rough measure of the traffic of a website. Other techniques involve the analyzing of the traffic between Web server and clients. The prior art techniques work well when the traffic of interest relates to particular pages, but are generally not informative when traffic by topic is desired, where one page may relate to multiple topics.

Another technique for determining the rating of video clips published on online video sites is based on viewership information provided by these sites. Typically, the sites count the cumulative number of users who view the clip. However, more refined measurements that include, for example, unique viewer counts per publisher, the number of viewers in different predetermined periods of time, and the number of users that commented or rated the clip, are neither generated by video sharing websites nor by any other prior art technique.

It would be therefore advantageous to provide a solution for online video analytics.

### SUMMARY OF THE INVENTION

A method and apparatus for online video analytics is disclosed that provides a cross-platform, online video analytics solution that enables advertisers and content publishers to assess the effectiveness of their video clips better, gain more insights into viewership demographics and behavior, and track and compare online video viewership across multiple video sharing websites.

### BRIEF DESCRIPTION OF THE DRAWINGS

FIG. 1 is a diagram of a network used to describe the various embodiments disclosed herein in accordance with the invention;

FIG. 2 is a block diagram of the VAS disclosed in accordance with an embodiment of the invention;

FIGS. 3A through 3H are exemplary charts generated by the VAS; and

FIG. 4 is a flowchart describing the process for computing a day's views in accordance with an embodiment of the invention.

### DETAILED DESCRIPTION OF THE INVENTION

A method and apparatus for online video analytics is disclosed herein. The system is a cross-platform, online video analytics solution. It enables advertisers and content publishers to assess the effectiveness of their video clips better, gain more insights into viewership demographics and behavior, and track and compare online video viewership across multiple video sharing websites.

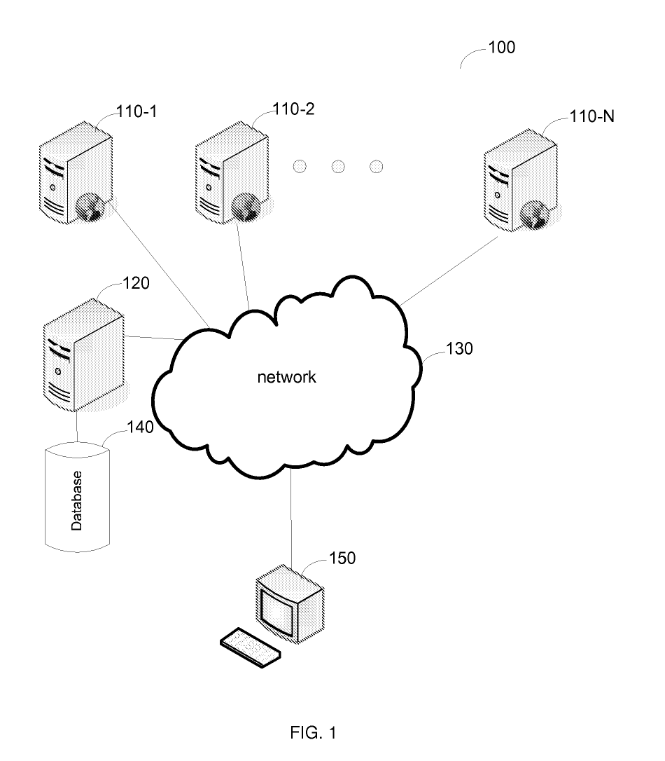

FIG. 1 shows an exemplary and non-limiting diagram of a network 100 that is used to describe the various embodiments disclosed in accordance with the invention. The network 100 includes a plurality of web servers 110 for hosting video sharing websites. The websites include, but are not limited to, YouTube™, MetaCafe™, Google® video, Yahoo!® video, myspace.com®, users' blogs, and the like. A viewership analytics server (VAS) 120 is connected to each of web servers 110 through a network 130 which may be, for example, the Internet. The VAS 120 executes the tasks related to gathering of viewership information for web servers 110, analyzing the gathered information, and generating viewership-related analytics data. These tasks are described in greater detail below. The VAS 120 is connected to a database 140 where the collected and generated viewership data is saved. In accordance with the invention, users, e.g. advertisers and content publishers, can access the VAS 120 through a client 150. The users can define the websites, publishers, and video clips to trace. In accordance, with an embodiment of the invention, the client 150 must log-in to a website to access the VAS 120. Through the website, the client can interact with VAS 120 and view the generated data.

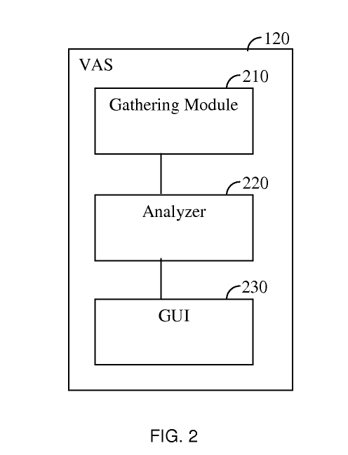

FIG. 2 shows an exemplary and non-limiting block diagram of the disclosed VAS 120 implemented in accordance with an embodiment of the invention. The VAS 120 includes a viewership information gathering module 210, an analyzer, and a graphical user interface (GUI) module 230. The gathering module 210 collects viewership information from web servers 110 at a predefined time of the day. The viewership information includes cumulative number of viewers, comments, ratings, i.e. number of user that rated the video, of each video clip displayed by websites hosted by servers 110. In accordance with one embodiment, the gathering module 210 retrieves the viewership information using an API. This embodiment can be used when the number of viewers of a particular video data is provided by the website. In accordance with another embodiment, the viewership information is retrieved by means of a web-crawler. Specifically, the web-crawler retrieves web-pages from web servers 110 that include viewership information, parses these pages, and extracts at least the numbers of viewers for each video clip displayed on the page. The viewership information gathered from websites is saved as, for example, an XML file in the database 140. Specifically, the database 140 includes for each clip, identified by its ID, at least the number of viewers in each day, the respective day, and the source website.

The analyzer 220 processes the information saved in the database 140 to generate viewership-related analytics data. The analyzer 220 determines the number of viewers during any period of time, e.g. last three days, last week, last months, etc. This information can be generated for a single website or across multiple websites. For example, the analyzer 220 can compute the number of viewers during the last two days of a specific video clip that is published on YouTube, myspace, and Yahoo! Video. Furthermore, the analyzer 220 produces aggregated viewership information per publisher or a group of video clips over different periods of time. This information can be generated for a single website or across multiple websites. For example, the analyzer 220 can compute the number of viewers of all video clips published by the publisher CBS on YouTube, myspace.com, and Yahoo! video during the last two weeks. The analyzer 220 can also compare the number of viewers between different publishers. This information can be generated for a single website or across multiple websites. To generate the viewership-related analytics data mentioned herein, the analyzer 220 first computes the number of viewers in each day, or any other time interval, from the gathered information, saves this data in the database 140, and queries the database 140 to generate the viewership-related analytics data.

The GUI 230 displays the viewership-related analytics data produced by the analyzer 220 as charts or text-based reports. In accordance with an embodiment of the invention, the charts are dynamic charts. That is, the GUI 230 dynamically changes the displayed content of the chart as the user changes the chart's time scale.

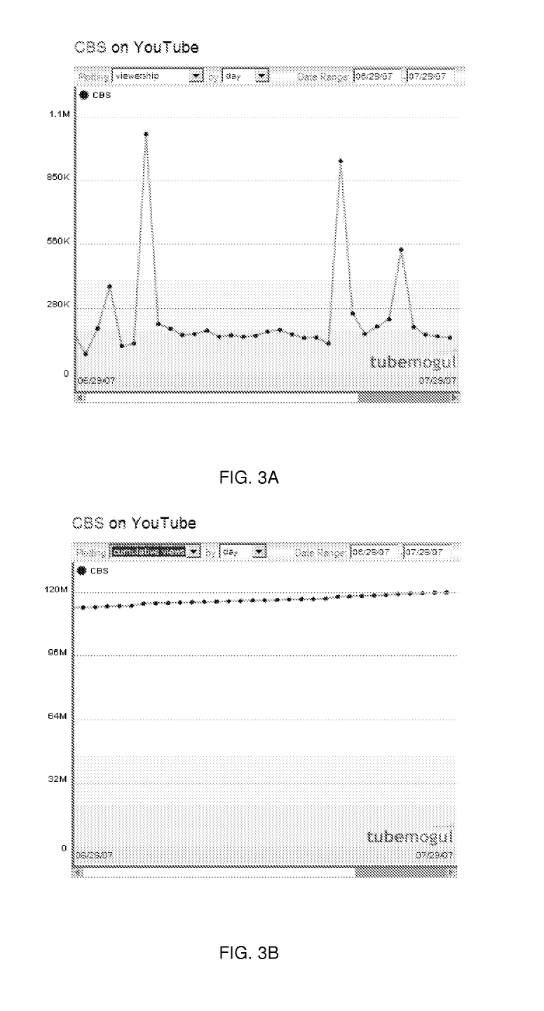

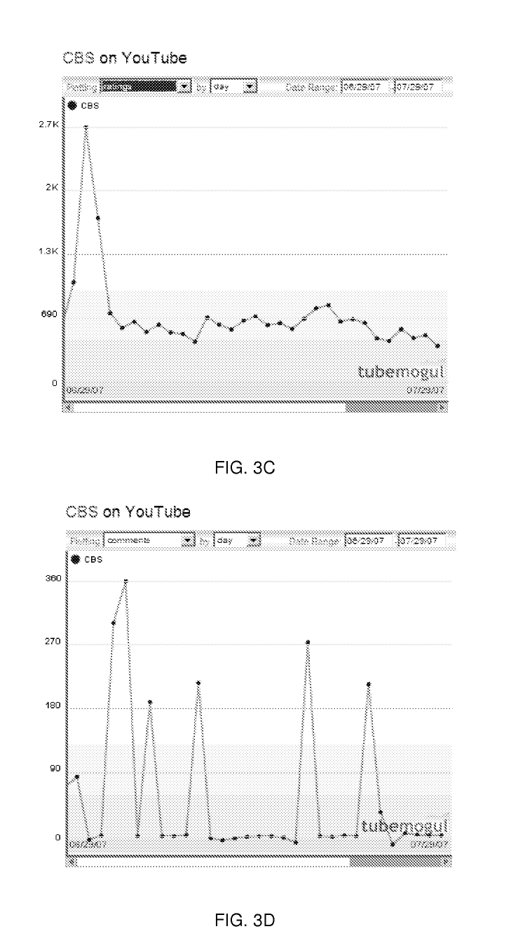

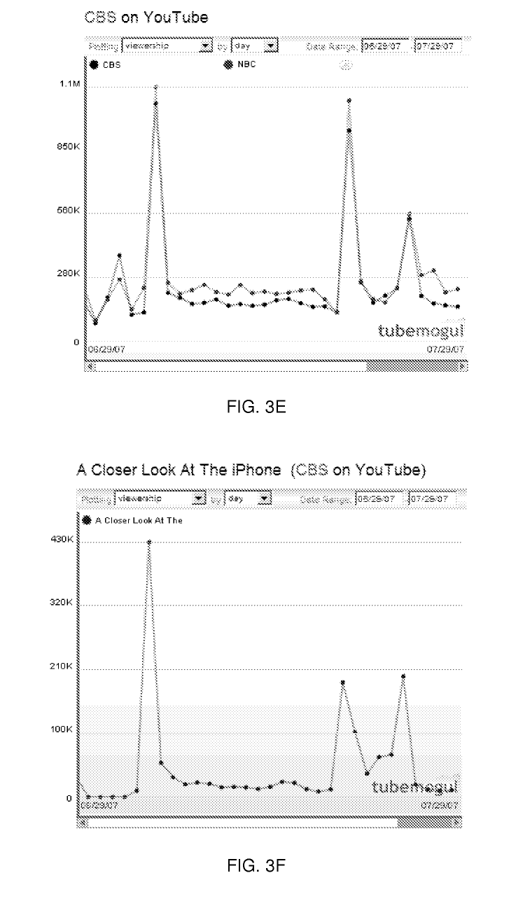

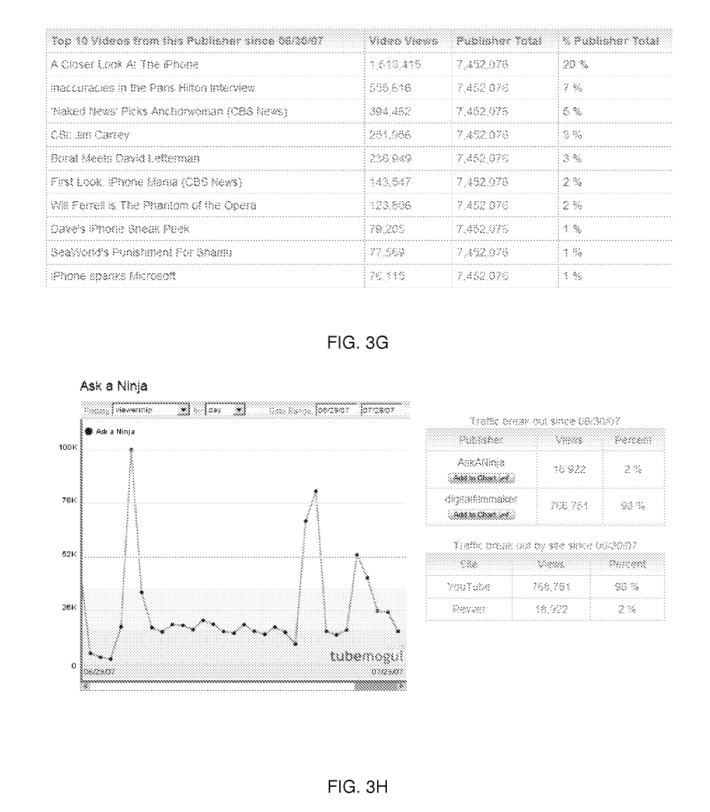

FIG. 3 shows a series of charts and reports generated by the GUI 230 in accordance with an embodiment of the invention. FIG. 3A is a chart that shows the number viewers of CBS's video clips on the website YouTube during a month. FIG. 3B is a chart that shows the cumulative number of viewers of CBS's video clips on the website YouTube during a month. FIG. 3C is a chart that displays the number of users who rated CBS's video clips on the website YouTube during a month. FIG. 3D is a chart that displays the number of users who commented CBS's video clips on the website YouTube during a month. FIG. 3E is a chart that shows the comparison between the number viewers of CBS and NBS video clips on the website YouTube during a month. FIG. 3F is a chart that shows the number viewers of a specific video clip published by CBS on the website YouTube during a month. FIG. 3G depicts a table that includes the top ten video clips of the publisher CBS. FIG. 3H is an example of the same publisher on two different websites YouTube and Revver. The chart of FIG. 3H represents an aggregate number of viewers.

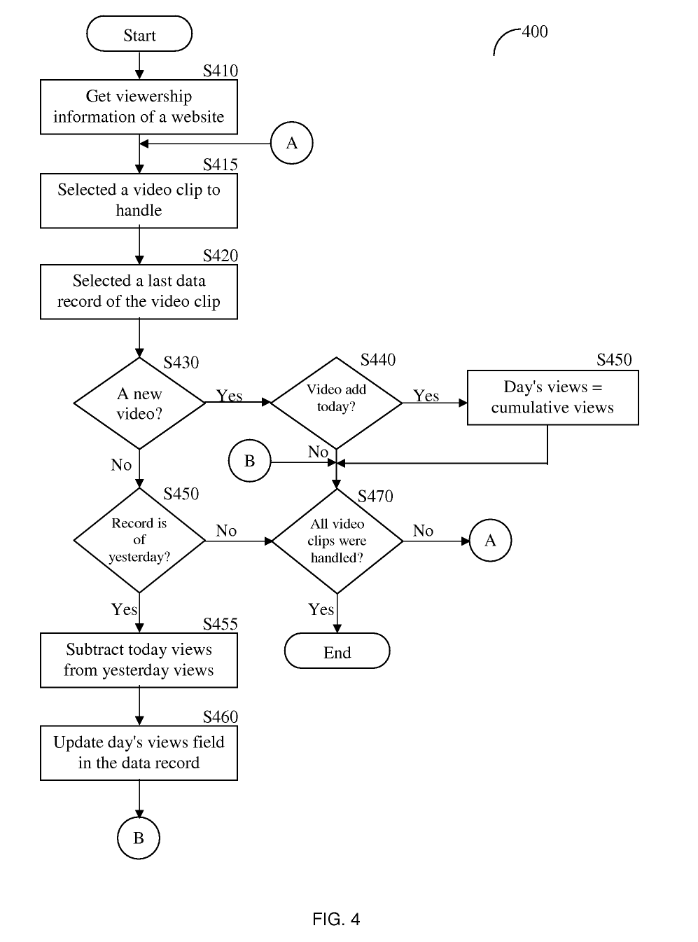

FIG. 4 shows an exemplary and non-limiting flowchart 400 describing the process for computing the number of viewers between two consecutive days in accordance with an embodiment of the invention. The purpose of the process is to determine the number of viewers in each specific day, hereinafter the day's views, for each video. At step S410, viewership information of a respective website collected by the gathering module 210 is retrieved from the database 140. At step S415, a video clip to be handled from the logged video clips is selected, and then at step S420, the last data record of that video clip is retrieved. A data record may include the website_ID, publisher_ID, video_ID, cumulative number of viewers as logged, day's views, and the date. An example of a data record is:
<YouTube, CBS, Myvideo, 1,002,000, 0, Jul. 30, 2007>
   where “YouTube” is the website_ID, “CBS” is the publisher_ID, “Myvideo” is the “video_ID”, 1,002,000 is the cumulative number of viewers, 0 is the day's views, and Jul. 30, 2007 relates to the last two fields. The day's views field is initialized to zero value.

At step S430 a check is performed to determine if the selected video clip is a new video and, if so, execution continues with step S440; otherwise, execution proceeds to step S450. At step S440 another check is performed to determine if this is the first day of the video clip on the website. If so, the number of the day's views is equal to the total number of viewers included in the data record; otherwise, execution continues with step S470.

At step S450 it is checked if the day as designated in the selected data record is of yesterday and, if so, execution continues with step S455, where the number of viewers in the data record is subtracted from the cumulative number of viewers logged today. For example, if the cumulative number of viewers as logged on Jul. 31, 2007 for the video_ID “Myvideo” is 1,002,900, then the day's views on Jul. 30, 2007 is 900, i.e. 1,002,900−1,002,000=900. At step S460, the subtraction result is updated in the selected data record in the day's views field. That is, the updated record of that shown above is:
<YouTube, CBS, Myvideo, 1,002,000, 900, Jul. 30, 2007>

If step S450 results with a NO answer, execution continues with step S470 where it is determined if all video clips of the respective website were handled. If so, execution ends; otherwise, execution returns to step S415.

The process 400 is described herein with a specific reference for computing the number of viewers. However, a person skilled in the art can easily adapt the process 400 to compute the number of comments and the number of ratings, i.e. users who rate and comment the video, on a specific day. Furthermore, a person skilled in the art can easily adapt the process 400 to compute viewership information, e.g. number of comments, viewers, and ratings, for different time intervals including, but not limited to, consecutive minutes, weeks, months, years, and so on, without departing from the scope of the disclosed invention.

It should be noted to a person skilled in the art that methods, processes, and systems described herein can be implemented in software, hardware, firmware, or combination thereof. The implementation may be performed as well using a computer system having a processor and a memory under control of the processor, the memory storing instructions adapted to enable the processor to carry out operations as described above. The implementation may be realized, in a concrete manner, as a computer program product that includes a tangible computer readable medium holding instructions adapted to enable a computer system to perform the operations as described above.

Although the invention is described herein with reference to the preferred embodiment, one skilled in the art will readily appreciate that other applications may be substituted for those set forth herein without departing from the spirit and scope of the present invention. Accordingly, the invention should only be limited by the Claims included below.

1. An apparatus for online video analytics, comprising:
a viewership information gathering module for collecting viewership information from a plurality of video sharing websites;
an analyzer for generating viewership-related analytics data from said collected viewership information; and
a graphical user interface (GUI) for displaying the viewership-related analytics data produced by the analyzer.

2. The apparatus of claim 1, further comprising:
a database for storing the retrieved viewership information and the generated viewership-related analytics data.

3. The apparatus of claim 1, wherein the video sharing websites are hosted by a plurality of web servers.

4. The apparatus of claim 3, wherein the gathering module collects viewership information at a predefined time of the day.

5. The apparatus of claim 3, wherein the gathering module collects viewership information using a web-crawler.

6. The apparatus of claim 5, wherein the web-crawler comprises means for:
retrieving web pages that include viewership information from web servers;
parsing the retrieved web pages; and
extracting at least the numbers of viewers for each video clip displayed on the page.

7. The apparatus of claim 6, wherein the viewership information comprises at least one of:
cumulative number of viewers, cumulative number of comments, and cumulative number of viewers who rated the video clip.

8. The apparatus of claim 7, wherein the analyzer comprises:
means for determining the number of viewers in a video clip during any period of time for a single video sharing website or across a plurality of video sharing websites.

9. The apparatus of claim 8, wherein the analyzer comprises:
means for determining the number of viewers in all video clips of a publisher during any period of time for a single video sharing website or across a plurality of video sharing websites.

10. The apparatus of claim 1, wherein the GUI displays the data in the form of charts and text-based reports.

11. A computer implemented method for tracking online video viewership across a plurality of video sharing websites, comprising the steps of:
gathering viewership information from a plurality of video sharing websites;
processing the gathered viewership information to generate viewership-related analytics data; and
displaying the generated viewership-related analytics data.

12. The method of claim 11, further comprising the step of:
saving the gathered viewership information and the generated viewership-related analytics data in a database.

13. The method of claim 11, wherein the gathered viewership information comprises at least one of:
cumulative number of viewers, cumulative number of comments, and cumulative number of viewers who rated the video clip.

14. The method of claim 13, wherein the step of gathering the viewership information further comprises the steps of:
retrieving web pages that include viewership information from web servers;
parsing the retrieved web pages; and
extracting at least the numbers of viewers for each video clip displayed on the page.

15. The method of claim 14, wherein the step of processing the gathered viewership information to generate the viewership-related analytics data further comprises the step of:
computing the number of viewers during a fixed time interval;
saving the number of viewers in a database; and
querying the database to generate the viewership-related analytics data.

16. The method of claim 15, wherein the viewership-related analytics data comprises at least the number of viewers in a video clip during any period of time for a single video sharing website or across a plurality of video sharing websites.

17. The method of claim 16, wherein the viewership-related analytics data comprises at least the number of viewers in all video clips of a publisher during any period of time for a single video sharing website or across a plurality of video sharing websites.

18. A computer program product for tracking online video viewership across a plurality of video sharing websites, the computer program product having computer instructions on a tangible computer readable medium, the instructions being adapted to enable a computer system to perform operations comprising the steps of:
gathering viewership information from a plurality of video sharing websites;
processing the gathered viewership information to generate viewership-related analytics data; and
displaying the generated viewership-related analytics data.

19. The computer program product of claim 18, being further adapted to enable a computer system to perform operations comprising the step of:
saving the gathered viewership information and the generated viewership-related analytics data in a database.

20. The computer program product of claim 19, wherein the gathered viewership information comprises at least one of:
cumulative number of viewers, cumulative number of comments, and cumulative number of viewers who rated the video clip.

21. The computer program product of claim 20, wherein the step of gathering the viewership information further comprises the steps of:
retrieving web-pages from web servers that include viewership information;
parsing the retrieved web pages; and
extracting at least the numbers of viewers for each video clip displayed on the page.

22. The computer program product of claim 21, wherein the step of processing the gathered viewership information to generate the viewership-related analytics data further comprises the steps of:
computing the number of viewers during a fixed time interval;
saving the number of viewers in a database; and
querying the database to generate the viewership-related analytics data.

23. The computer program product of claim 22, wherein the viewership-related analytics data comprises at least the number of viewers in a video clip during any period of time for a single video sharing website or across a plurality of video sharing websites.

24. The computer program product of claim 23, wherein the viewership-related analytics data comprises at least the number of viewers in all video clips of a publisher during any period of time for a single video sharing website or across a plurality of video sharing websites.
